(19) United States
(12) Patent Application Publication
(10) Pub. No.: US 2014/0172442 A1
(43) Pub. Date: Jun. 19, 2014

(54) Systems and Methods to Assess Clinical Status and Response to Drug Therapy and Exercise

(71) Applicants: Jeff Broderick, San Francisco, CA (US); James Kovach, Larkspur, CA (US)

(72) Inventors: Jeff Broderick, San Francisco, CA (US); James Kovach, Larkspur, CA (US)

(21) Appl. No.: 14/045,763

(22) Filed: Oct. 3, 2013

Related U.S. Application Data
(60) Provisional application No. 61/709,330, filed on Oct. 3, 2012.

(51) Int. Cl. G06F 19/00

(52) U.S. Cl. CPC G06F 19/3481
USPC 705/2

(57) ABSTRACT

New methods and machine implemented systems measure patient health symptoms and clinical endpoints, communicate prescribed exercise programs to patients, coach or encourage patients to exert themselves within a predetermined protocol or beyond accustomed levels (in treatment of Parkinson's disease), or below accustomed levels (in treatment of cardiac rehabilitation), track patient compliance to exercise instructions, record and commutate data for physician review and for system optimization wherein databases of exercise programs may be modified to comport with measured patient success. Measurements of patient exercises and health changes are also used to provide refined diagnosis and status of disease. Individual exercise programs may be modified in response to physician input and/or patient progress. The continues loop feedback between a patient and the system optimizes the use of exercise as a treatment for disease.

### CROSS-REFERENCE TO RELATED APPLICATIONS

This is a utility application based upon U.S. patent application Ser. No. 61/709,330 filed on Oct. 3, 2012. This related application is incorporated herein by reference and made a part of this application. If any conflict arises between the disclosure of the invention in this utility application and that in the related provisional application, the disclosure in this utility application shall govern. Moreover, the inventors incorporate herein by reference any and all patents, patent applications, and other documents hard copy or electronic, cited or referred to in this application.

### BACKGROUND OF THE INVENTION

(1) Field of the Invention

The invention generally relates to means and methods of assessing compliance with exercise instructions and continually monitoring patient health. More particularly, the invention relates to means and methods of using personal electronic devices to facilitate the monitoring and coaching of patient exercise and the adjustment of patient treatment in response to changes in patient health.

(2) Description of the Related Art

U.S. published patent application 2011/0082397, “Systems and Methods for Motor Function with Assisted Exercise” by Alberts published on Apr. 7, 2011 discloses a forced exercise system that includes a motorized system of assisting a patient's movement of an exercise implement. Alberts includes monitoring devices to report the amount of force contributed by the patient as compared to the amount of force provided by an electric motor. In one embodiment, Alberts uses a stationary bicycle peddled by a patient and uses a motor to assist the patient's movement of the peddles. Exertion by the patient is reviewed and compared to the force provided by the motor.

Alberts fails to provide artful means of measuring patient health, coaching or encouraging patents to exercise within a predetermined protocol, monitoring a patient's activities throughout the day or other needed features.

U.S. Pat. No. 6,454,706 “System and Method for Clinically Assessing Motor Function” issued on Sep. 24, 2002 to Pullman teaches spiral testing but fails to provide an integrated system as presently disclosed.

Thus, there is room in the art for the various disclosed embodiments of the present invention.

### BRIEF SUMMARY OF THE INVENTION

The present invention overcomes shortfalls in the related art by presenting an unobvious and unique combination and configuration of methods and components to measure patient health, communicate prescribed exercise programs to patients, coach or encourage patients to exert themselves within a predetermined protocol, track patient compliance to exercise instructions, record and commutate data for physician review and other features as described herein.

Disclosed embodiments include the use of exercise-based treatments intended to improve patient function, slow the progression of symptoms for patients having disease conditions and to minimize the use of medication. Studies suggest that patients have a lifetime limit or tolerance for the intake of certain medications for such aliments as Parkinson's disease and that providing the lowest effective dose will extend the time period of drug induced relief.

Embodiments of the present invention provide patients means of performing daily non-supervised physical function tests to continuously ascertain a patient's physical and disease condition. The continuous flow of such information helps to define the lowest effective dose of a medication and to make daily changes to a prescribed exercise program. In the prior art, patients would seek out a health care provider for weekly or monthly exams and evaluations.

Disclosed embodiments include the use of patient dashboards or other interfaces, heart rate sensors, cadence sensors, accelerometers and other sensors to measure patient health and activity.

Disclosed embodiments include a high-cadence cycling regimen that is responsive to a patient's ability to pedal quickly (cadence) and a patient's ability to exert themselves, with exertion sometimes measured by heart rate.

Disclosed embodiments include integration with the Unified Parkinson's Disease Rating Scale (UPDRS). The UPDRS comprises a five section rating scale sometimes used to follow the longitudinal progression of a patient with Parkinson's disease. The UPDRS test may measure mental conditions, ability to execute daily activities and evaluation of motor conditions. The test has been clinically proven as valid even when self-administered.

Disclosed embodiments include systems for coaching a recovering concussion patient through rehabilitation. Light exercise may be prescribed and if the patient experiences symptoms, the patient may press a symptom button on an electronic device. Upon pressing the button, the system may stop the exercise session and record the type of symptom reported. Such information may be stored in a database and use to adjust the subsequent workouts of the patient.

Disclosed embodiments include systems of coaching physical therapy wherein heart rate and walking cadence are monitored over time to see if a patient's exertion levels decrease over time for the same activity levels, such a result indicates that the patient is becoming more physically efficient at their tasks over time.

Disclosed embodiments include machine implementation of analytics wherein a prescribed exercise plan is monitored in real time and stored on the server for longitudinal analysis. A score is generated to simplify the understanding of patient's compliance with their plan. The score may be generated by comparing the second-by-second workout performance, and recording time (sometimes measured in seconds) and degrees of difference compiled over the course of the workout.

For example, the plan for second number 60 calls for 90 RPM cadence and 130 BPM heart rate. The patient's actual readings are 87 RPM cadence and 140 BPM heart rate. The difference for this second and every other second of the workout may be included in a score calculation. There are also high and low bands for certain targets such as heart rate. Staying within the bounds of each high and low range constitutes a degree of compliance to an exercise plan and counts towards the score. For example, for a heart rate range plan of between 110 and 130 BPM with a target of 120, if a patient's actual heart rate is 124, an interface would show zone compliance but 4 BPM away from the target level. Longitudinal analysis of compliance using a system score may be summarized on a screen page or computer interface, showing progress over time. A system of badges simplifies the status of compliance for the user.

Disclosed embodiments include machine generated alerts issued when patient compliance changes dramatically, an early diagnostic tool for determining a change in a patient's condition and calls to action directed toward health care providers.

Disclosed embodiments include workout screens or interfaces showing scores, compliance figures, time in zones and compliance charts.

Disclosed embodiments include means, methods and systems to encourage a patient to exercise or to exert themself within a predetermined protocol or customized exercise plan. Disclosed embodiments include means, methods and systems to encourage patients to exert themselves below accustomed levels, a method sometimes used in the treatment of cardiac rehabilitation patients. Sometimes, for the treatment of Parkinson's disease, patients are encouraged or mechanically coached to engage in exertion beyond their accustomed levels of exertion.

These and other objects and advantages will be made apparent when considering the following detailed specification when taken in conjunction with the drawings.

### BRIEF DESCRIPTION OF THE DRAWINGS

FIG. 1 is a schematic flow chart of a disclosed system

FIG. 2 depicts a disclosed embodiment showing a doctor server and a patient server

FIG. 3 is a listing of database tables

FIG. 4 is a disclosed embodiment

FIG. 5 is a disclosed machine embodiment

FIG. 6 is a view of product components

FIG. 7 is a schematic view of a first step

FIG. 8 is a schematic view of a second step

FIG. 9 is a schematic view of a third step

FIG. 10 is a schematic view of a fourth step

FIG. 11 is a schematic view of a fifth step

FIG. 12 is a schematic view of a sixth step

FIG. 13 is a schematic view of a seventh step

FIG. 14 is a screen view of a workout interface

FIG. 15 depicts four workout profiles

FIG. 16 depicts a workout screen

FIG. 17 depicts a longitudinal analysis of a patient's progress

FIG. 18 depicts a screen view of a tremor analysis

FIG. 19 depicts a screen view of a spiral analysis

### REFERENCE NUMERALS IN THE DRAWINGS

100 applications or system functions
110 system to test patient symptoms prior to exercise
115 system to test patient symptoms after exercise
120 system to measure patient performance as compared to exercise plan
130 system of coaching or encouraging a patient to exercise within a predetermined protocol or predetermined level of exertion
140 system of exercise
200 sensors
210 measuring and reporting systems
220 foot pod sensor
230 heart rate monitor
240 speed and cadence sensor
300 receiving server accepting sensor data
310 server in communication with a patient and sensors used by a patient
320 server in communication with a doctor or other health care provider 710
400 server for outgoing instructions and therapy plans
500 mobile device or personal computer
600 an exercise device
700 a patient
710 a doctor or other health care provider
800 distributed computer network
900 machine readable media with machine readable instructions
920 a general or specialized computer processor
930 memory in communication with a processor 920
1000 database of patient information
1010 database of workout libraries
1020 database of patient tests
1030 database of disorders
1040 database of workout effectiveness rankings
1045 a database of compliance and symptom data across a population or plurality of patients
1100 database tables
1105 database table of patient data
1110 database table of patient disorders
1115 database table of workout data
1120 database table of workout summaries
1125 database table of workouts or exercise plans
1130 database table of disorders
1135 database table of tests
1140 database table of genetics
1145 database table of symptom analysis
1150 database table of nutrition
1155 database table of medication
1160 database table of symptom summaries
1165 database table of patient regimens
1170 database table of regimen schedules
1175 database table of schedule compliance
1200 product components in general
1205 desktop version of a patient dashboard
1210 workout or exercise interface
1215 workout or exercise report interface shown on an electronic tablet
1220 workout or exercise report interface shown on a personal electronic mobile device, such as a smart phone
1225 cadence sensors or other sensors used by a patient
1300 a personalized workout program
1400 a system of loading a personalized workout to a patient's mobile device 1120
1405 a system of a coached workout
1410 a system of processing patient performance or workout data and providing feedback to the patient
1415 a wireless sensor or other patient worn device transmitting exercise or patient data to a patient mobile device or patient server
1420 a system of transmitting patent workout data to a computer implemented system
1425 a database table or database of workout archives
1430 a system of processing or analyzing workout data on the server side
1435 workout files
1437 workout summary
1439 workout score
1440 tests of symptoms
1442 a system of symptom analysis
1444 a summary of symptom analysis
1446 a system of analysis analytics
1448 an analysis score
1450 a system of compliance and symptom mapping
1452 a system of analysis of a patient's workout and analysis of a patient's compliance to the workout
1460 a system of optimization
1500 a plurality of workout profiles targeted to specific health concerns
1505 a first workout profile for a patient with Parkinson's disease
1507 a second workout profile for a patient with Parkinson's disease
1510 a workout profile for a patient who had a concussion
1520 a workout profile for a patient who had a stroke
1600 a workout interface
1610 an interface showing a longitudinal analysis including score over time
1700 an interface for tremor analysis
1710 an interface for spiral analysis

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

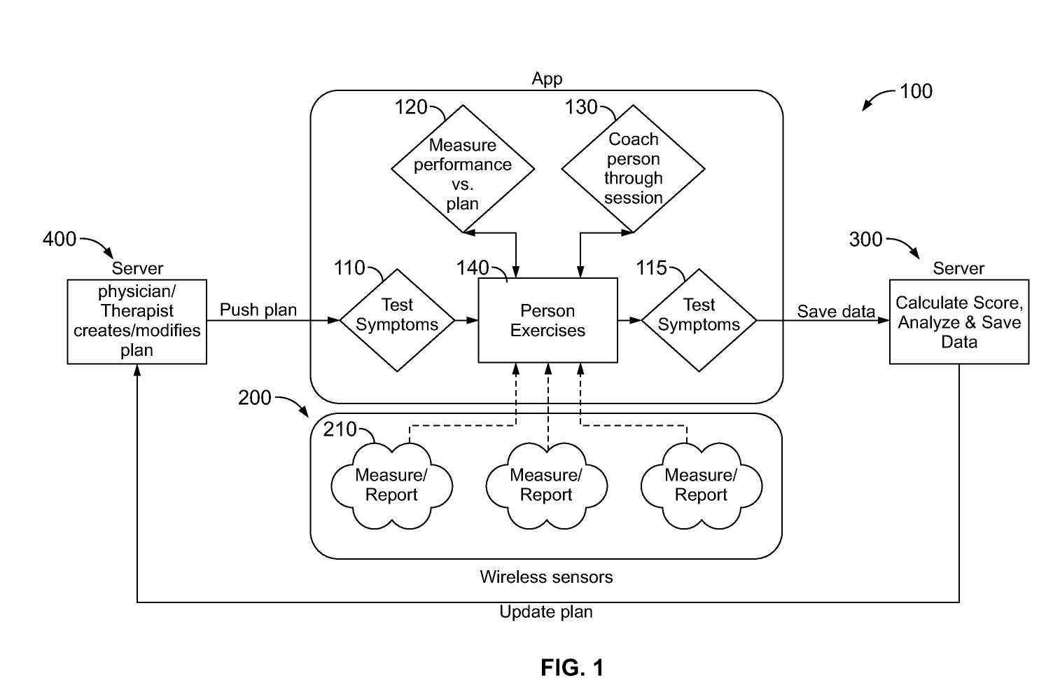

FIG. 1 provides a schematic view of one contemplated flow chart of operations. After a health care provider examines a patient, an exercise plan is created and placed upon a push server 400 or plan server, the exercise plan is then transmitted or pushed to a patient. Before executing the exercise plan, the patient uses a smart phone or other personal electronic device “PED” to assist in self-testing for symptoms. Such tests include using an accelerometer within the PED to check for involuntary shaking.

After pre-exercise test 110, the patient begins exercising 140 and a system component 120 compares measured patient performance to the exercise plan. During exercise, a coaching system 130 provides visual, auditory or tactile output to coach or encourage the patient to either, stay within the exertion levels of the exercise plan, stay within exertion levels below accustomed levels or engage in exertion beyond accustomed levels. By review of comparisons generated by the measurement 120 component, the coaching component 130 may accurately and precisely access the incremental levels of effort needed for a patient to reach the goals of the prescribed exercise plan. The coaching component may also take into consideration a patient's prior levels of physical exertion, and if allowed in the current exercise plan, motivate or encourage the patent to exercise within a predetermined protocol or predetermined level of exertion.

After completion of an exercise session, post exercise tests 115 are performed by the patient to ascertain post exercise health and to provide input for consideration in analyzing the effectiveness of the exercise session. Data from all of the application systems 100 is transmitted to a receiving server system 300 wherein data is stored, scored and analyzed before an updated plan is sent to the plan server 400. When a new plan is received, a health care provider may review the plan and modify the exercise plan as needed and modify the dosage of medicine as appropriate. A modified exercise plan and new dosage plan is then pushed to the patient and the cycle repeats as needed.

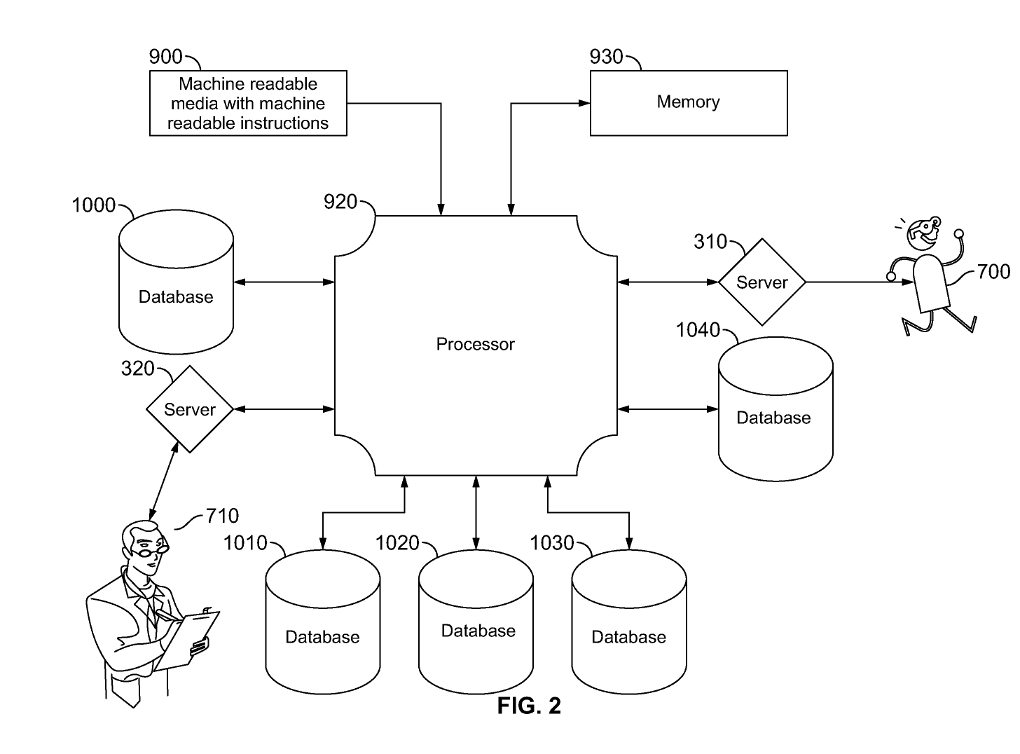

FIG. 2 depicts a machine implementation of disclosed embodiments the implementation comprises a computer readable media 900 containing machine readable instructions, not shown, the instructions reflecting the movements of data and system operations of the disclosed embodiments. The machine implementation future comprises a processor 920, or plurality of processors that may be general processors or a specialized processors configured to execute the disclosed embodiments. General memory 930 or non-volatile memory may be in communication with the processor or plurality of processors. The processor(s) may be in communication with a plurality of servers or other network connections. Servers may include a doctor/health care provider server 320 and a patient server 310. A plurality of databases may be in communication with the servers and/or the processor(s).

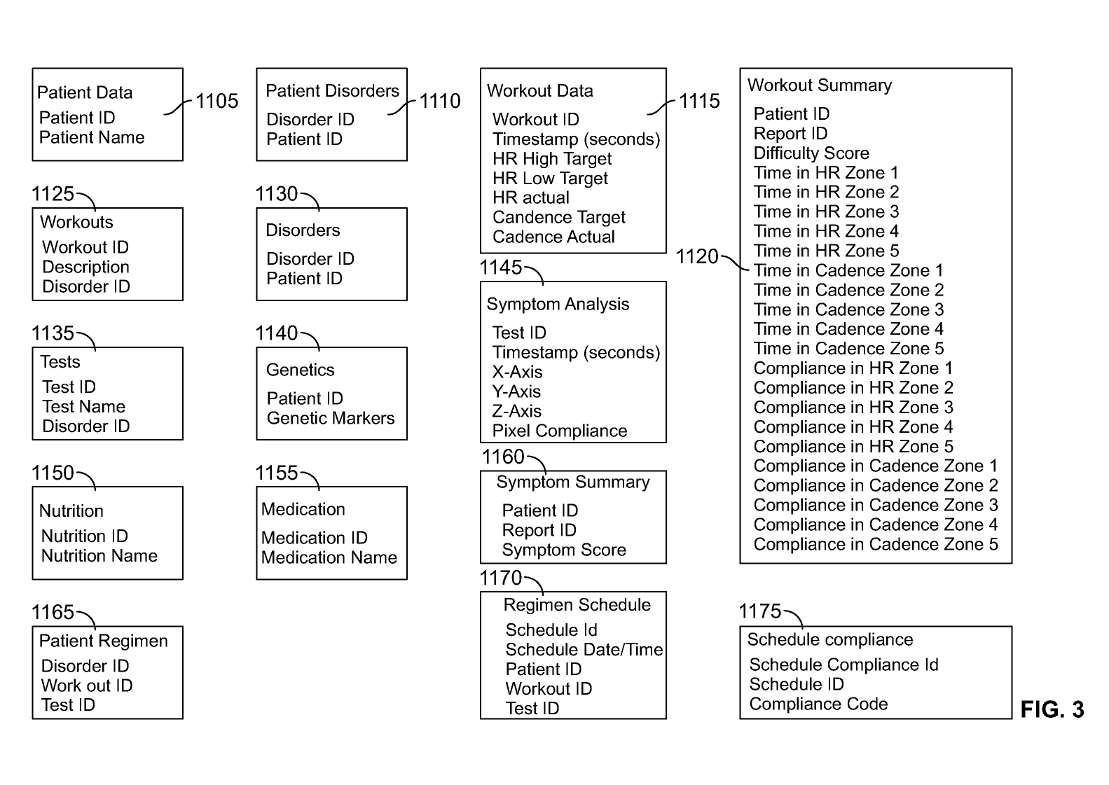

Such databases may include databases containing: patient information 1000, workouts or workout libraries 1010, tests for patients to take 1020, disorders 1030, effectiveness rankings 1040, compliance and symptom data across a population or plurality of patients 1045. Databases may also include or comprise the database tables described in FIG. 3.

FIG. 3 depicts a plurality of additional databases and/or database table. The term “database table” is used interchangeably with the term “database.” The database tables or databases of FIG. 3 may include a plurality of information fields as shown. For example, database table or database of patient data 1105 may contain fields of information or categories of information that include patient ID and patient name. Disclosed embodiments may comprise the following database tables or databases: patient data 1105, patient disorders 1110, workout data 1115, workout summary 1120, workouts 1125, disorders 1130, tests 1135, genetics 1140, symptom analysis 1145, nutrition 1150, medication 1155, symptom summary 1160, patient regimen 1165, regimen schedule 1170 and schedule compliance 1175.

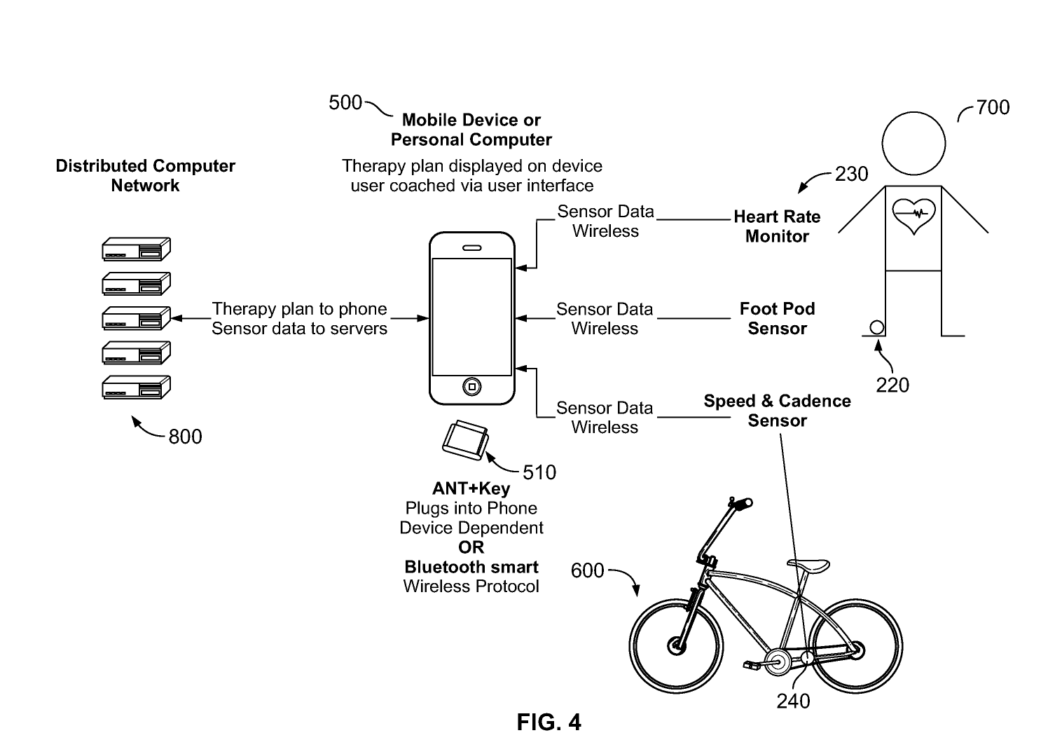

FIG. 4 depicts an ecosystem view of a contemplated embodiment wherein a patient 700 operates an exercise device 600 while the patient is attached to a heart rate monitor 240, foot pod sensor 220 and the exercise device is attached to a speed and cadence sensor 240. The various sensors are shown to wirelessly send data to a mobile device, personal computer or PED 500 via an antenna and key system 510. The PED accepts data from the sensors and the PED transmits coaching data to the patient. The PED 500 is in communication with a distributed computer network 800 to send out patient and sensor data and to accept modified exercise plans, coaching data and optimal dosage information.

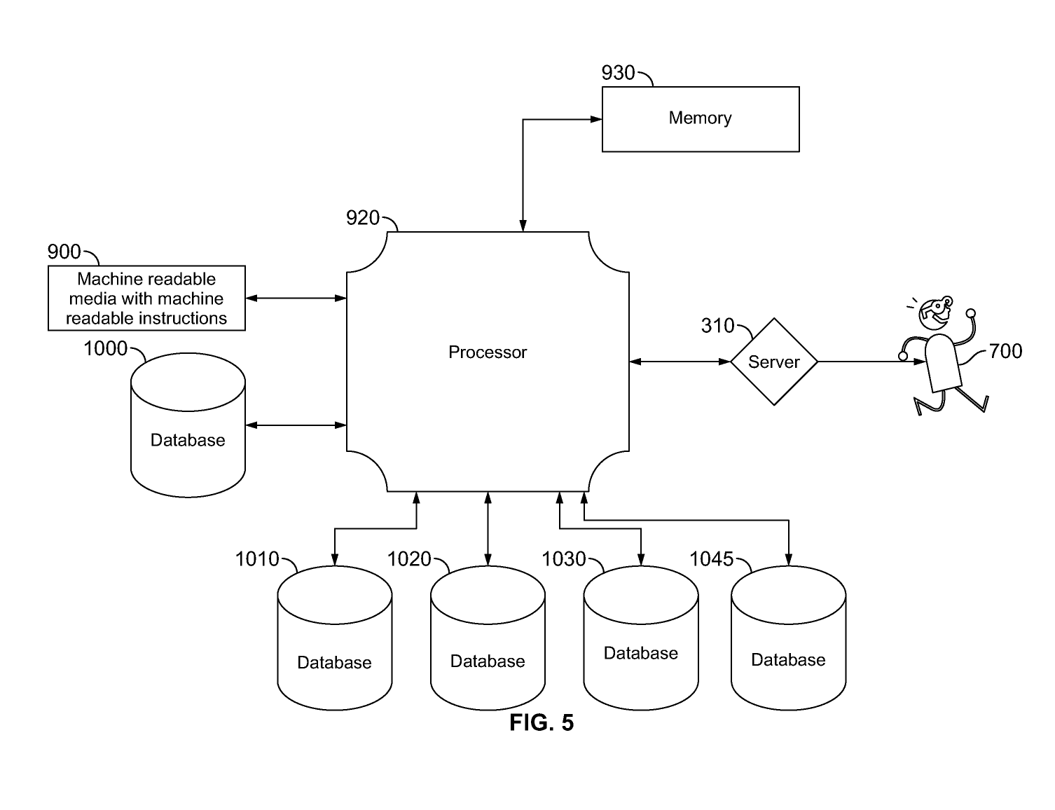

FIG. 5 depicts a disclosed machine enabled embodiment similar to that of FIG. 2. While a plurality of servers are disclosed, FIG. 5 depicts one patient server 310 in communication with a patient 700 and machine system, including one or more general or specialized processors 920. The machine implementation of FIG. 5 includes a database 1045 of compliance and symptom data across a population or plurality of patients. The machine readable media may contain non signal information and be comprised of a tangible piece of media.

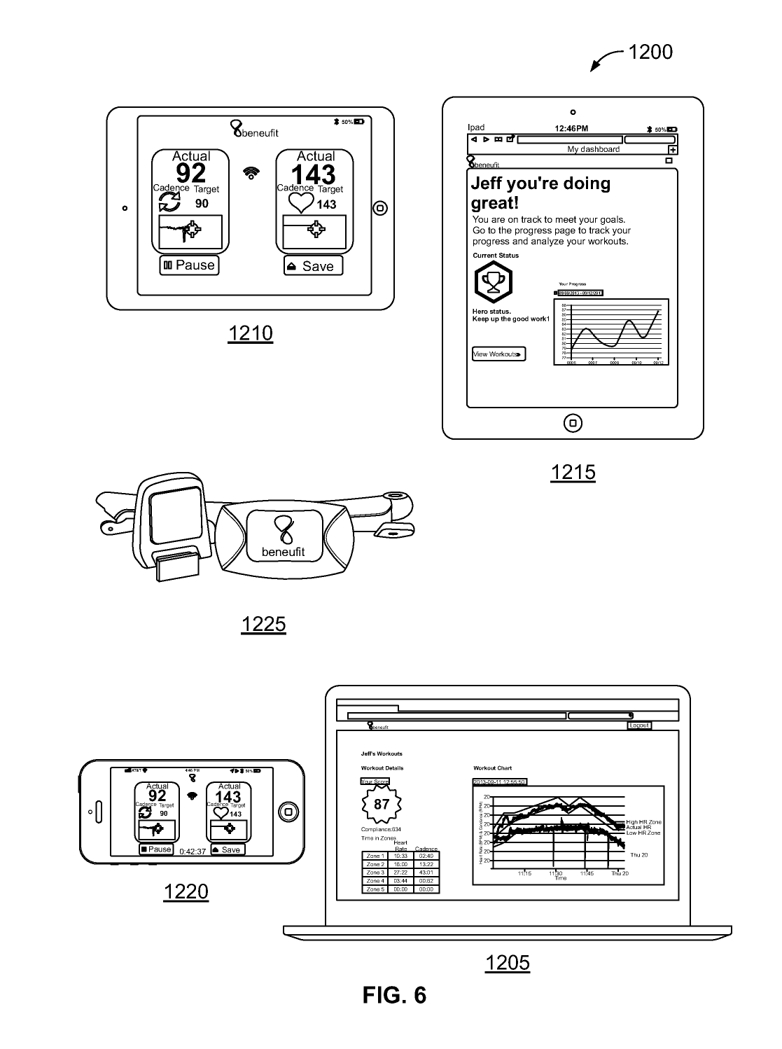

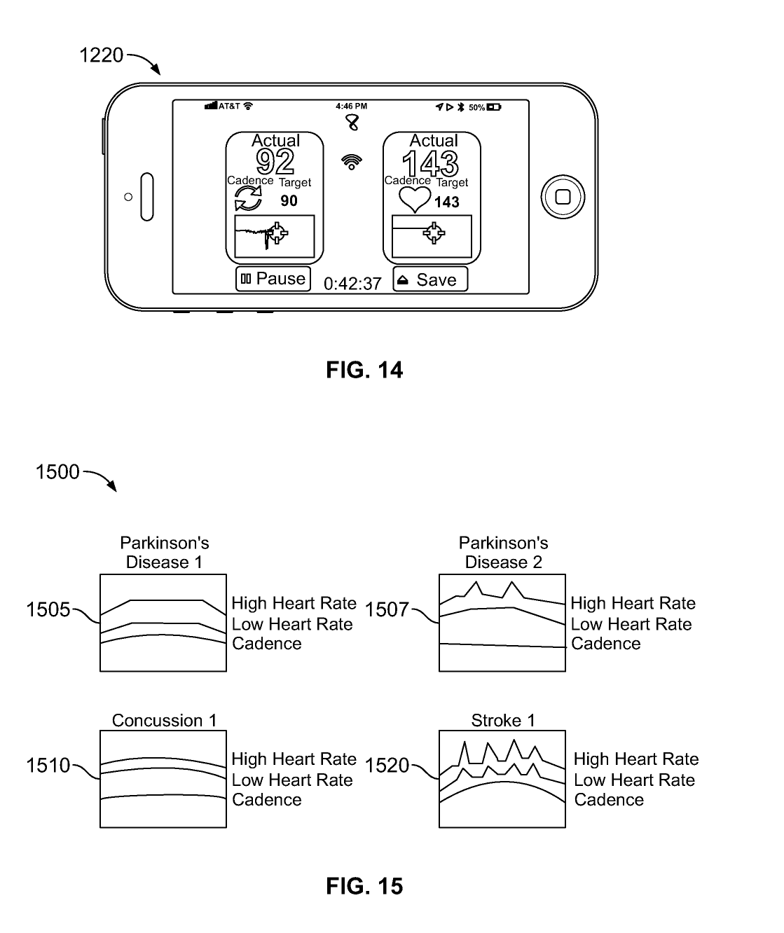

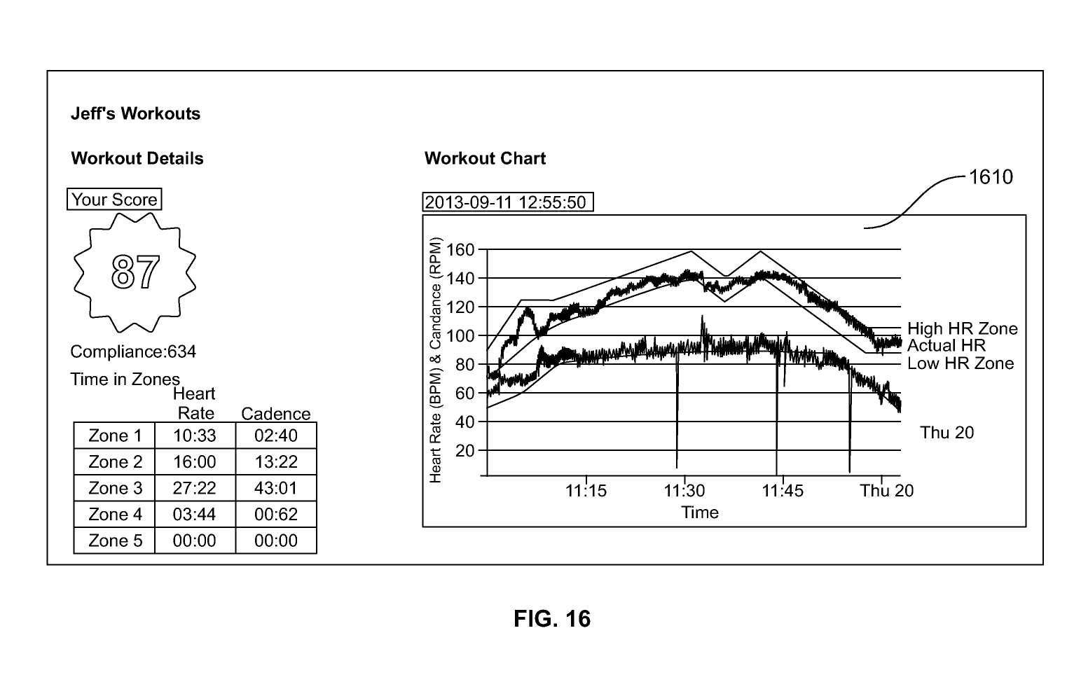

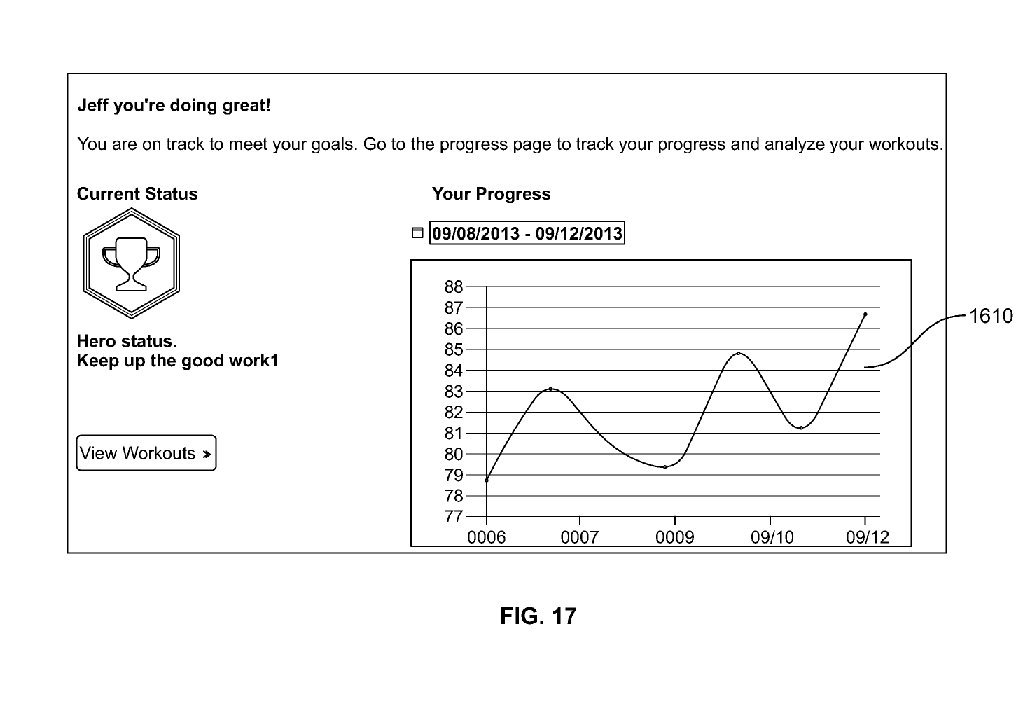

FIG. 6 depicts a plurality of system components in general 1200. More specifically embodiments may include a desktop version 1205 of a patient dashboard, shown in more detail in FIG. 16, a workout or exercise interface 1210, shown in more detail in FIG. 14, a workout or exercise report interface shown on an electronic tablet 1215, the interface is shown in more detail in FIG. 17.

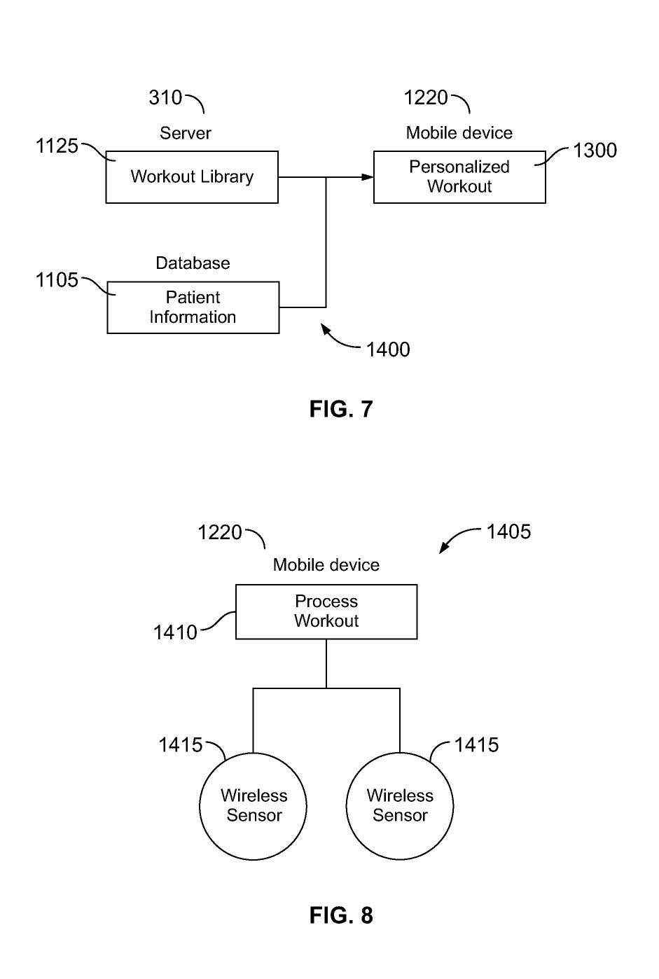

FIG. 7 depicts step one 1400 or a first step of a disclosed embodiment, the step comprising a workout library database 1125 in communication with a server 310 and a patient information database or debatable also in communication with the server 310. The server 310 using instructions from the machine readable media 900 to create a personalized workout 1300 sent to the patient's mobile device 1220.

FIG. 8 depicts a coached workout step or system 1405 comprising sensors 1415 attached or near a patient, and the sensors 1415 in communication with a patient's mobile device 1220. A process workout system 1410 or step may take place within the mobile device 1220 or via communication with a system server. In a coached workout step 1405 or system, a patient may receive feedback regarding exercise performance. Such feedback may take the form of encouragement and or user interfaces, such as those shown in FIGS. 14, 16 and 17.

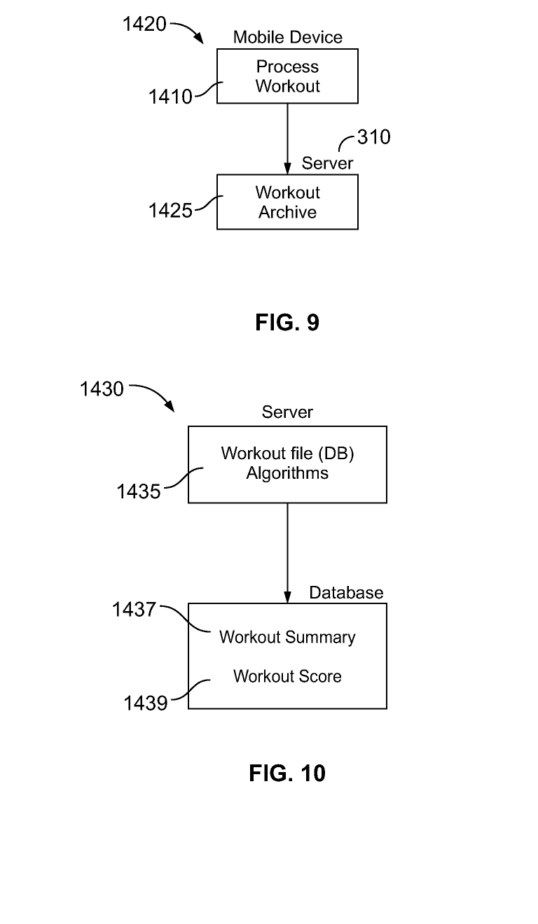

FIG. 9 depicts a system 1420 of transmitting processed workout data 1410 to a workout archive database 1425.

FIG. 10 depicts a system 1420 of processing or analyzing workout data and transmitting such data to databases storing workout summaries 1437 and workout scores 1439. In general, workout files within a database are processed with various steps or algorithms to derive workout summaries and workout scores, such as the information shown in FIGS. 14, 16 and 17.

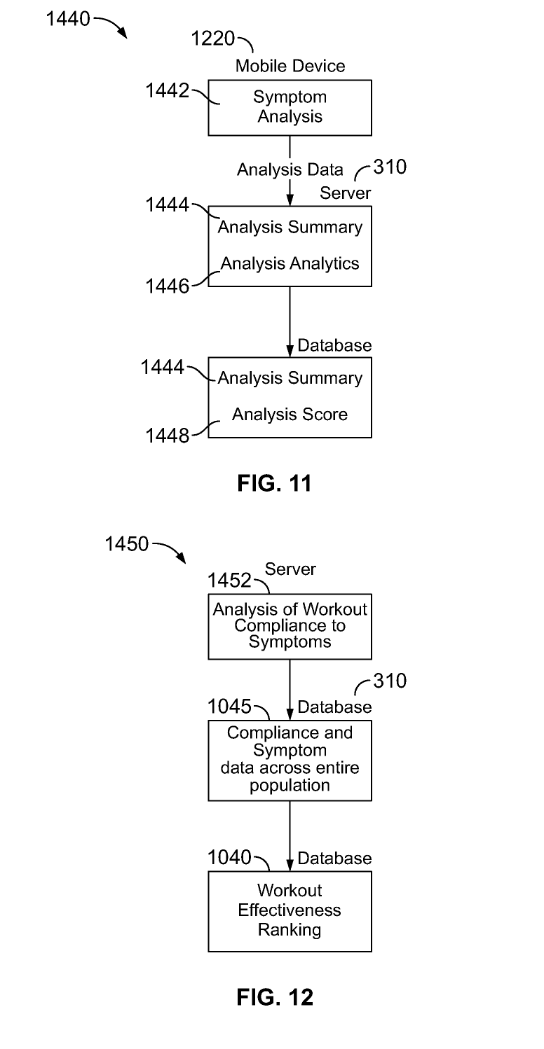

FIG. 11 depicts a process of testing symptoms 1140 which may comprise a mobile device collecting patient data, performing a symptom analysis, and transmitting such analysis to a system server. In an alternative embodiment, a mobile device sends raw data to the system server wherein symptom analysis is derived. A server may use machine readable instructions and database information and/or instructions to perform or derive symptom analysis.

A server my compile a analysis summary 1444 for a particular patient or a plurality of patients and a server may also compile analysis analytics 1446 for a particular patient or a plurality of patients. The analysis summary 1444 may be stored within a database along with an analysis score 1448.

FIG. 12 depicts a step or system of compliance and/or symptom mapping 1450, comprising a server receiving patient data and performing an analysis of workout compliance to symptoms 1452 and sending such analysis to a database 1045 to record and/or further compile compliance and symptom data across an entire population or across a plurality of patients. The compliance and symptom data may be further processed and made part of a workout and effectiveness ranking database 1040.

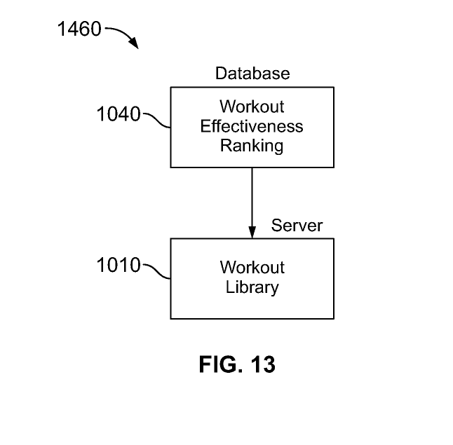

FIG. 13 depicts an optimization step or process 1460 wherein the database of workout effectiveness rankings 1040 are used to augment or modify the contents the workout library. Such modifications help to optimize the workout library 1010 such that future exercise programs are more tailored to a patient's specific needs.

FIG. 14 depicts a pseudo screen shot of a disclosed interface 1220 wherein actual and target heart rates are shown in real time and stored for future reference.

FIG. 15 depicts a plurality of workout profiles 1500 targeted to specific health concerns, the workout profiles comprising a first workout profile 1505 for a patient with Parkinson's disease, a second workout profile 1507 for a patient with Parkinson's disease, a workout profile 1510 for a patient who had a concussion, a workout profile 1520 for a patient who had a stroke.

FIG. 16 depicts an interface or screen view of a workout screen 1600 showing score, compliance figure, time spent in target zones, and a compliance chart.

FIG. 17 depicts a longitudinal analysis screen 1610 showing score values mapped over time.

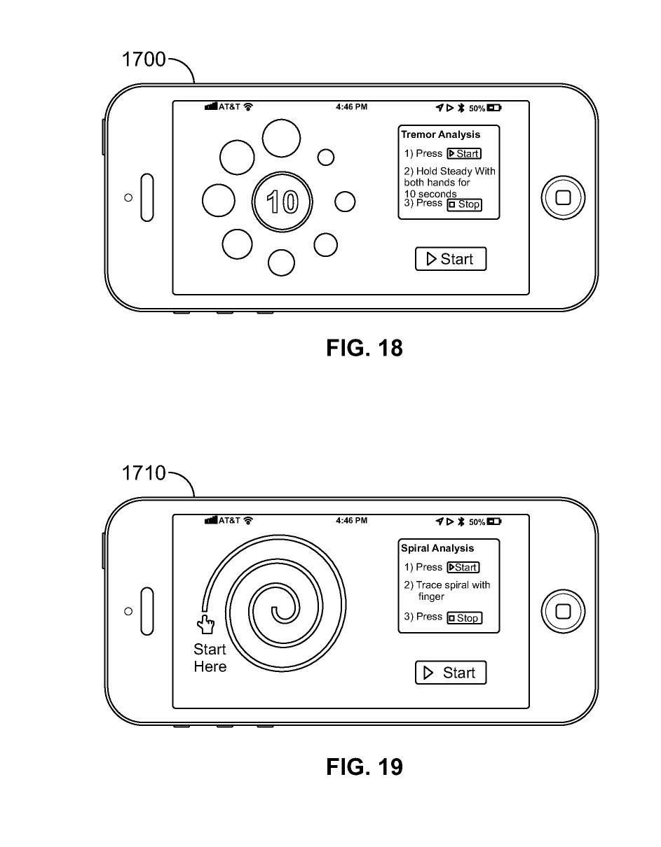

FIG. 18 depicts a tremor analysis interface 1700 wherein a patient may hold an electronic device and the electronic device, using accelerometers and other components, measure the stability or muscular control of the patient.

FIG. 19 depicts a spiral analysis interface 1710 which may be used to measure muscular control.

Embodiments include the production of a score calculated at the end of each exercise session. Such a score may correlate a patient's performance, derived by sensor data, to an exercise or therapy plan. Such a score may be used to track patient compliance and to report variables such as exercise time, exertion level (sometimes measured in watts) heart rate, blood pressure, respiratory rate, and cadence.

Embodiments are HIPAA compliant and gather and store longitudinal data to facilitate comparisons between different interventions in individual patients or groups of patients.

Disclosed embodiments may be used for treatment and analysis for a wide variety of disease, including neurodegenerative disorders, dementias, extrapyramidal diseases, motor neuron diseases, and systemic atrophies primarily affecting the central nervous system.

Disclosed embodiments have been used with excellent results with patients suffering from symptoms caused by Parkinson's disease, stroke, traumatic brain injury and Alzheimer's disease

Disclosed embodiments allow for the diagnosis of subcategories of Parkinson's disease by review of a patient's response to exercise.

Disclosed embodiments allow for the treatment and refined diagnosis, (by measuring patient responses to the exercise) of the following diseases:

Neurodegenerative Disorders
Ataxia telangiectasia
Autosomal dominant cerebellar ataxia
Batten disease
Corticobasal degeneration
Creutzfeldt-Jakob disease
Fatal familial insomnia
Infantile Refsum disease
Locomotor ataxia
Lyme disease
Machado-Joseph disease
Mental retardation and microcephaly with pontine and cerebellar hypoplasia
Multiple system atrophy
Neuroacanthocytosis
Niemann-Pick disease
Pontocerebellar hypoplasia
Pyruvate dehydrogenase deficiency
Refsum disease
Sandhoff disease
Shy-Drager syndrome
Spinocerebellar ataxia
Subacute combined degeneration of spinal cord
Tabes dorsalis
Tay-Sachs disease
Toxic encephalopathy
Wobbly hedgehog syndrome

Dementias:
Agnosia
Alzheimer's disease
Anomic aphasia
Anosognosia
Apraxia
Apraxia of speech
Art and dementia
Auditory verbal agnosia
Dementia with Lewy bodies
Early-onset Alzheimer's disease
Familial British dementia
Frontotemporal dementia
Frontotemporal lobar degeneration
HIV-associated neurocognitive disorder
Ideational apraxia
Logopenic progressive aphasia
Phonagnosia
Pick's disease
Primary progressive aphasia
Progressive nonfluent aphasia
Semantic dementia
Steroid dementia syndrome
Tauopathies
Vascular cognitive impairment
Vascular dementia
Visuospatial dysgnosia

Extrapyramidal Diseases
Huntington's disease
Parkinson's disease
Dystonias
Mohr-Tranebjærg syndrome
Neuroleptic malignant syndrome
Pantothenate kinase-associated neurodegeneration
Parkinsonism
Postencephalitic parkinsonism
Progressive supranuclear palsy
Shy-Drager syndrome

Motor Neuron Diseases
Amyotrophic lateral sclerosis
Chronic traumatic encephalopathy
Distal hereditary motor neuropathies
Distal spinal muscular atrophy type 1
Fazio-Londe disease
Infantile progressive bulbar palsy
Spinal and bulbar muscular atrophy
Madras motor neuron disease
Monomelic amyotrophy
Progressive muscular atrophy
Post-polio syndrome
Primary lateral sclerosis
Progressive bulbar palsy
Pseudobulbar palsy
Spinal muscular atrophy
X-linked spinal muscular atrophy type 2

Systemic Atrophies Primarily Affecting the Central Nervous System
Ataxia telangiectasia
Autosomal dominant cerebellar ataxia
Cerebellar ataxia
Congenital distal spinal muscular atrophy
Friedreich's ataxia
Harding ataxia
Hereditary spastic paraplegia
Juvenile primary lateral sclerosis
Machado-Joseph disease
Primary lateral sclerosis
Progressive bulbar palsy
Spinocerebellar ataxia

Items

Disclosed embodiments may include the following items.

Item 1. A machine implemented system for treating disease by use of customized exercise programs obtained from a database of exercise programs, coaching of patients during exercise, recording patient performance, recording changes in patient health, and using the recorded information to modify the patient's customized exercise program, the system comprising:

a machine readable media 900 containing non-volatile machine readable instructions, the machine readable instructions in communication with a processor 920, the processor in communication with machine memory 930, the processor in communication with a plurality of databases, the databases comprising: a database of patient information 1000, a database of workout libraries 1010, a database of patient tests 1020; a database of disorders 1030; a database of effectiveness rankings, a database of symptom analysis 1145 and a database of schedule compliance 1175;

a patient server 310 in communication with the processor and the patient server in communication with a patient's electronic device and the patient's electronic device in communication with sensors attached to the patient;

a user interface 1220 presenting coaching instructions to a patient during exercise;

a user interface measuring post exercise heath conditions of a patient;

the patient's electronic device sending recorded information to the plurality of databases;

the patient's recorded information used to modify the patient's customized exercise programs.

Item 2. The system of item 1 further used for optimizing the database of workout libraries by modifying the database of workout libraries by use of changes to the database of effectiveness rankings.

Item 3. The system of item 2 further used for refined diagnosis of disease by measurement of patient responses to customized exercise programs.

Item 4. The system of item 3 further comprising a doctor server in communication with the processor.

Item 5. The system of item 3 further comprising machine readable instructions directing the user interface 1220 to instruct a patient to exert themselves within exertion boundaries of the customized exercise program.

Item 6. The system of item 5 further comprising customized exercise programs configured to instruct a patient to exercise at an exertion level below a patient's accustomed level of exertion.

Item 7. A method of using a machine implemented system for treating disease by use of customized exercise programs obtained from a database of exercise programs, coaching of patients during exercise, recording patient performance, recording changes in patient health, and using the recorded information to modify the patient's customized exercise program, the system comprising:

a machine readable media 900 containing non-volatile machine readable instructions, the machine readable instructions in communication with a processor 920, the processor in communication with machine memory 930, the processor in communication with a plurality of databases, the databases comprising: a database of patient information 1000, a database of workout libraries 1010, a database of patient tests 1020; a database of disorders 1030; a database of effectiveness rankings, a database of symptom analysis 1145 and a database of schedule compliance 1175;

a patient server 310 in communication with the processor and the patient server in communication with a patient's electronic device and the patient's electronic device in communication with sensors attached to the patient;

a user interface 1220 presenting coaching instructions to a patient during exercise;

a user interface measuring post exercise heath conditions of a patient;

the patient's electronic device sending recorded information to the plurality of databases;

the patient's recorded information used to modify the patient's customized exercise programs.

Item 8. The method of item 7 used for optimizing the database of workout libraries by modifying the database of workout libraries by use of changes to the database of effectiveness rankings.

Item 9. The method of item 7 used for creating a refined diagnosis of disease by measurement of patient responses to customized exercise programs.

Item 10. The method of item 7 further using a doctor server in communication with the processor.

Item 11. The method of item 7 using machine readable instructions directing the user interface 1220 to instruct a patient to exert themselves within exertion boundaries of the customized exercise program.

Item 12. The method of item 7 using customized exercise programs configured to instruct a patient to exercise at an exertion level below a patient's accustomed level of exertion.

Item 13. Using the method of item 7 for treatment of Parkinson's disease.

Item 14. Using the method of item 7 for treatment of Alzheimer's disease.

Item 15. Using a specialized processor in using the system of item 12.

What is claimed is:

1. A machine implemented system for treating disease by use of customized exercise programs obtained from a database of exercise programs, coaching patients during exercise, recording patient performance, recording changes in patient health, and using the recorded patient information to modify the patient's customized exercise program, the system comprising:
a machine readable media containing non-volatile machine readable instructions, the machine readable instructions in communication with a processor, the processor in communication with machine memory, the processor in communication with a polarity of databases, the databases comprising: a database of patient information, a database of workout libraries, a database of patient tests; a database of disorders; a database of effectiveness rankings, a database of symptom analysis and a database of schedule compliance;
a patient server in communication with the processor and the patient server in communication with a patient's electronic device and the patient's electronic device in communication with sensors attached to the patient;
a user interface presenting coaching instructions to a patient during exercise;
a user interface measuring post exercise heath conditions of a patient;
the patient's electronic device sending recorded information to the plurality of databases;
the patient's recorded information used to modify the patient's customized exercise programs.

2. The system of claim 1 further comprising an optimization of the database of workout libraries by modifying the database of workout libraries by use of changes to the database of effectiveness rankings.

3. The system of claim 2 further used for refined diagnose of disease by measurement of patient responses to customized exercise programs.

4. The system of claim 3 further comprising a doctor server in communication with the processor.

5. The system of claim 4 further comprising machine readable instructions directing the user interface to instruct a patient to exert themselves within exertion boundaries of the customized exercise program.

6. The system of claim 5 further comprising customized exercise programs configured to instruct a patient to exercise at an exertion level below a patient's accustomed level of exertion.

7. A method of using a machine implemented system for treating disease by use of customized exercise programs obtained from a database of exercise programs, coaching patients during exercise, recording patient performance, recording changes in patient health, and using the recorded information to modify the patient's customized exercise program, the system comprising:
a machine readable media containing non-volatile machine readable instructions, the machine readable instructions in communication with a processor, the processor in communication with machine memory, the processor in communication with a plurality of databases, the databases comprising: a database of patient information, a database of workout libraries, a database of patient tests, a database of disorders, a database of effectiveness rankings, a database of symptom analysis and a database of schedule compliance;
a patient server in communication with the processor and the patient server in communication with a patient's electronic device and the patient's electronic device in communication with sensors attached to the patient;
a user interface presenting coaching instructions to the patient during exercise;
a user interface measuring post exercise heath conditions of the patient;
the patient's electronic device sending recorded information to the plurality of databases; and
the patient's recorded information used to modify the patient's customized exercise programs.

8. The method of claim 7 used for optimizing the database of workout libraries by modifying the database of workout libraries by use of changes to the database of effectiveness rankings.

9. The method of claim 7 used to create a refined diagnosis of disease by measurement of patient responses to customized exercise programs.

10. The method of claim 7 used to create a diagnosis of disease status by measurement of patient responses to customized exercise programs.

11. The method of claim 7 used to create a refined diagnosis of Parkinson's disease by using measurements of patient responses to customized exercise programs.

12. The method of claim 7 using machine readable instructions directing the user interface to instruct the patient to exert themselves within exertion boundaries of the customized exercise program.

13. The method of claim 7 using comprising customized exercise programs configured to instruct the patient to exercise at an exertion level below a patient's accustomed level of exertion.

14. Using the method of claim 7 for treatment of Parkinson's disease.

15. Using the method of claim 7 for treatment of Alzheimer's disease.

16. For the method of claim 7, using a specialized processor.
